(19) United States
(12) Patent Application Publication
(10) Pub. No.: US 2003/0102647 A1
(43) Pub. Date: Jun. 5, 2003

(54) Anti-theft bicycle

(76) Inventor: James Vincent Morrone, Old Town, ME (US)

Correspondence Address: Mr. JAMES MORRONE, LAFAYETTE STATION, P.O. BOX 26, BOSTON, MA, 02112, US

(21) Appl. No.: 10/174,290

(22) Filed: Jun. 13, 2002

Related U.S. Application Data
(63) Continuation of application No. 08/499,582, filed on Jul. 7, 1995, now abandoned.
(63) Continuation of application No. 08/784,981, filed on Jan. 17, 1997, now abandoned.
(63) Continuation of application No. 09/630,533, filed on Aug. 1, 2000, now abandoned.

(51) Int. Cl. B62K 1/00

(52) U.S. Cl. 280/281.1

(57) ABSTRACT

A non-motorized bicycle frame construction, comprising anti-theft apparatus which is a permanent integral part of the bicycle frame when constructed.

The anti-theft apparatus is set in a permanent place, and continueously ready for instantaneous and easy use by the rider.

The anti-theft apparatus not requiring a changing from one location on the bicycle frame, to another location for actual use, and then back to the original location on the bicycle frame when the device is not in use.

### RELATED APPLICATIONS

This application is a continuation of the following earlier filed and copending applications on related subject matter:

Ser. No. 08/499,582, Filed: Jul. 7, 1995 and now abandoned;

Ser. No. 08/784,981, Filed: Jan. 17, 1997, and now abandoned.

Ser. No. 09/630,533, Filed: Aug. 1, 2000, and now pending.

### BACKGROUND OF THE INVENTION

The present invention relates in general and exclusively to apparatus for a non-motorized conventional bicycle frame construction, to be used for preventing theft of a bicycle, and further used for preventing theft of a bicycle tire or tires from the bicycle frame.

The conventional bicycle frame, with or without changeable speed mechanism's has no anti-theft apparatus which is integral with the bicycle frame when constructed.

Many times the person who is riding the bicycle has to carry locks and chains and sometimes tools in order to secure the bicycle or bicycle tires from theft while the rider is away from the bicycle attending to other things.

Another frequent occurrence for preventing theft of the bicycle tires is one tire is often removed from its normal usable place and coupled together with the other tire and locked to the bicycle frame.

This means that upon returning to the bicycle the rider has to unlock the tire and reinstall it back to its usable place and then put the lock away. Usually the lock has to be secured somewhere else on the bicycle frame. These are cumbersome and undesirable feats which take extra time and effort in order for the rider to have the convenience of leaving the bicycle.

Although there are a variety of locks presently being sold on the market for bicycles, none of them are as presented herein, set in position so as to be integral with the bicycle frame and permanently positioned to be ready for instantaneous use.

Instead the locks which are presently available and for sale are stored and locked somewhere else on the bicycle frame and away from the place where the lock is actually used.

This requires the rider of the bicycle to remove the lock from the place where it is stored and then carry the lock to the place where it is needed, and further install and position the lock so it will be able to be used, and then locate the key chamber on the lock so the rider will be able to access the chamber which in most instances is not in a position where the rider can instantly insert the key.

Furthermore, after returning and unlocking the lock, it must then be taken from its place of use and returned back to its place on the bicycle frame where it is stored, and then secured and locked in its stored place in order for the lock itself not to be stolen.

### SUMMARY OF THE INVENTION

Therefore, it is the object of the present invention to provide a bicycle frame with locks which having previously been set by the manufacturer in a permanent place on the bicycle frame, and continueously ready for instantaneous and easy use by the rider.

A further object of the present invention is to provide a bicycle frame wherein the front or back tire does not have to be removed away from its normal usable place in order to be locked to the bicycle frame to prevent theft.

A further object of the present invention is to provide a locking, securing means for the bicycle frame wherein the securing means may be pulled out of the bicycle frame tubing for use, and then received into a permanently positioned and continuously ready for instantaneous use locking mechanism which is designed to receive the pulled out securing means and lock the same therein.

A further object of the present invention is to provide a lock which has a pivoting member which is permanently anchored on one side of the bicycle frame and is adaptable to pivot, fit through the bicycle tire spokes or rim, and then engage with a receiving locking mechanism member which is also permanently located and continuously ready for instantaneous use on the opposite, other side of the bicycle frame, and locks the pivoting member therein for easy use.

A further object of the present invention is to provide a securing feature for the pivoting member, to maintain, hold the pivoting member in an out-of-the-way position without removing the pivoting member, and its receiving locking mechanism from their usable position.

A further object of the present invention is to provide the rider of the bicycle with locks for the bicycle frame which do not have to be removed from their usable place in order to ride the bicycle.

A further object of the present invention is to provide a place for the bicycle lock key to fit in the lock on the outerside of the bicycle frame for easy access to the key chamber for locking and unlocking the apparatus.

To accomplish the forgoing and many other objects and features and advantages of the invention there is provided a bicycle frame constructed of tubing-type material wherein is located a securing means.

This securing means is constructed of chain link-type members.

The chain is connected to a spring-type member which is also located within the tubing.

The spring is connected to a pin which is secured, anchored to the bicycle tubing, inside.

The tubing has an opening which is used for exposing a portion of the chain.

The exposed portion of the chain may be pulled out of the tubing by a persons finger.

After being pulled out, the chain is used to engage an object which is preferably secured and unmovable.

The object may be for instance, a fence or a telephone pole.

After engaging, wrapping the chain around the unmovable object, the chain is then secured, locked inside a locking mechanism which is located on the bicycle frame.

This locking mechanism is used for receiving the chain and is permanently positioned for instantaneous use and fastened to the bicycle frame.

This act secures the bicycle while the rider is away.

After returning to the bicycle and unlocking the chain, the spring which is located inside the tubing, pulls the chain back into the tubing.

This makes returning the chain effortless.

The rider of the bicycle does not have to remove the lock after unlocking the chain because the lock is permanently positioned and secured to the bicycle frame and always ready for instantaneous use.

The rider merely puts the key back in his or her pocket.

The chain does not have to be removed or stored away by the rider because the chain automatically returns back to its permanently positioned and always instantaneous ready to use place.

This now makes the securing of the bicycle, locking and unlocking easy.

It is further understood that although chain link-type material is used for securing the bicycle frame, other suitable type materials may be used for securing the bicycle frame, such as for instance, steel-type wire, or for that matter any other strong material which is suitable for this performance.

Of course, if another suitable type material is used, it shall comprise of all features that are included with the chain-link material, which are hereinafter mentioned, stop members, retracting member, ect.

In further reference to the anti-theft apparatus for bicycle tires, there is provided a pivoting member which is permanently attached and positioned so as to be always ready for instantaneous use.

The pivoting member is attached to a portion of the bicycle frame which supports the bicycle tire, namely the frame fork.

The pivoting member is received into a locking mechanism which is also permanently attached and positioned so as to be always ready for instantaneous use.

The locking mechanism is also attached to the bicycle frame fork.

After the pivoting member is received into the locking mechanism it is secured, locked therein, and is later released, unlocked by a key which fits into a chamber located in the locking mechanism.

The pivoting member is located on one side, and the locking mechanism is located on the opposite side of the bicycle frame.

The pivoting member is designed so as to fit through the bicycle tire spokes or bicycle tire rim, and thereby secure the bicycle tire to the fork, and thus prevent the tire from being removed from the bicycle frame.

It is understood that the pivoting member may also be inserted through the bicycle tire spokes or bicycle tire rim by being inserted straight through the spokes or rim without having to be pivoted there through.

It is further understood that the bicycle tire locking device may be modified and used for the aforesaid bicycle frame fork or to fit a bicycle frame which employs, uses a semi-fork instead of a full fork, namely a fork which employs only one leg.

It is further understood that if the bicycle tire locking device is modified, the concept remains the same and the device includes means for permanent securing in place on the bicycle frame for instantaneous use.

### BRIEF DESCRIPTION OF THE DRAWINGS

Numerous features and advantages of the invention should now become apparent upon a reading of the following detailed description taken in conjunction with the accompanying drawings in which;

FIG. 1 is a simulated partial perspective front view of the bicycle frame fork, and showing a bicycle tire locking device located in a permanent place and ready for instantaneous use.

FIG. 2 is a simulated partial perspective front view of the bicycle frame fork shown in FIG. 1, and illustrates the bicycle tire locking device engaged with the locking mechanism.

FIG. 3 is a simulated partial perspective front view of the bicycle frame fork shown in FIG. 2, and further illustrating a slot located in the locking device.

FIG. 4 is a simulated partial perspective view of the bicycle frame fork shown in FIG. 2, and illustrating the bicycle tire locking device pivoted through a bicycle tire spokes, or rim, and engaged with the device locking mechanism.

FIG. 5 is a simulated partial side view of a bicycle frame showing a break-away of the bicycle tubing, and further showing bicycle securing means comprising of chain-link members and a spring member located inside the tubing.

Also shown is an opening in the tubing with a portion of the chain exposed in the opening and ready for instantaneous extraction by a persons hand, the chain then to be used for securing the bicycle frame to an unmovable structure by wrapping the chain around the unmovable structure and then locking the chain in a locking mechanism which is also shown permanently attached to the bicycle frame and ready for instantaneous use.

FIG. 6 is a simulated partial side view of a bicycle frame.

FIG. 6 shows a modification or variation of the bicycle tire locking device.

FIG. 6 showing only a portion, one side of said modified bicycle tire locking device.

FIG. 6 showing said locking device permanently attached to said bicycle frame and ready for instantaneous use.

FIG. 7 illustrates the modified bicycle tire locking device shown in FIG. 6, now engaged with the bicycle tire.

FIG. 8 is a simulated partial side view of a bicycle frame.

FIG. 8 shows the opposite side of the bicycle frame shown in FIG. 6, and further shows the other remaining portion of the locking device and the locking mechanism where the key inserts.

FIG. 9 is a simulated partial front view of the modified or variation of the bicycle tire locking device shown in FIGS. 6-8, and illustrating both portions of the device engaged and locked together. The bicycle frame or tire is not shown.

FIG. 10 is a partial front view of the device shown in FIG. 9, and illustrating disengagement of the two portions.

FIG. 11 is a simulated partial front perspective view of a variation of a bicycle frame fork, and showing the fork having only one leg to be used for supporting a bicycle tire.

### DETAILED DESCRIPTION OF THE DRAWINGS

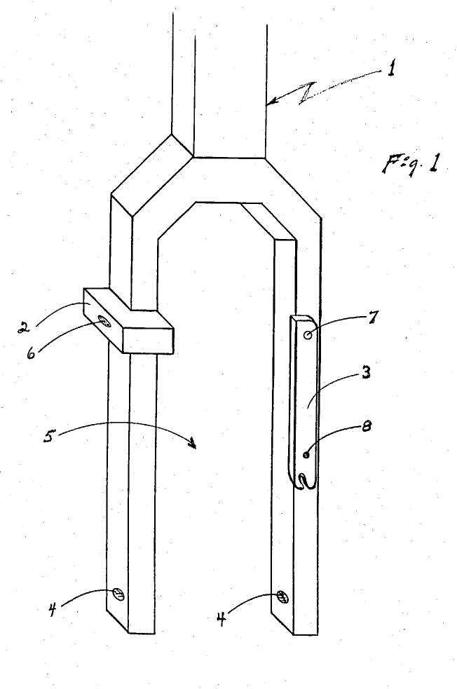

FIG. 1 shows the bicycle frame fork 1, with holes 4, shown in either side of the fork.

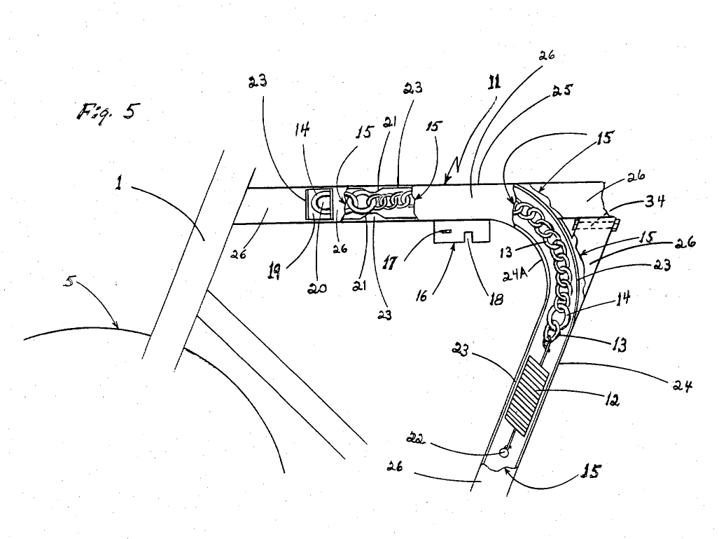

The holes are used for securing a bicycle tire 5, which is shown in FIG. 5, to the fork in the space located between the fork legs.

FIG. 1 also shows the pivoting member 3, being held in an out-of-the-way position, and secured to one leg of the bicycle fork.

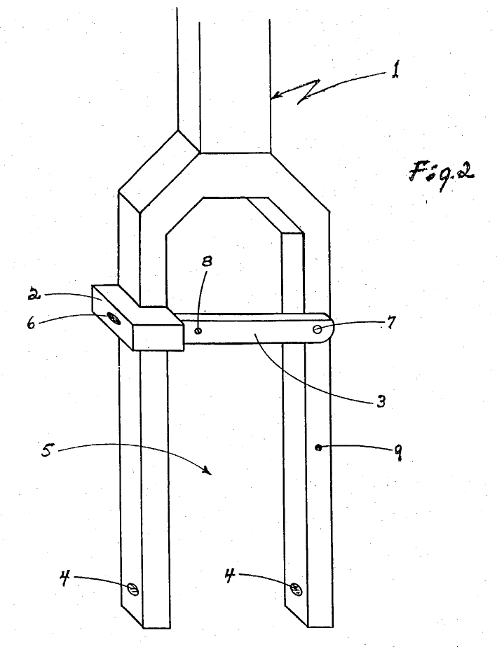

Said securing located at hole 8, wherein a ball shaped part 9, which is shown in FIG. 2, is engaged with said hole 8.

The pivoting member is also secured to said leg by a pin 7, which passes through the pivoting member and into the fork leg.

The pin 7, permanently secures, anchores the pivoting member to the leg and allows member 3, to pivot.

Also shown in FIG. 1 is a locking mechanism 2, used for securing, locking the pivoting member 3, therein.

Also shown is key slot 6, located in an easy to access position.

FIG. 2 illustrates the pivoting member 3, shown in FIG. 1, now engaged with locking mechanism 2.

The pivoting member 3, pivots through the bicycle tire 5, rim, which is to be located between the fork legs.

The pivoting member is then received into the locking mechanism 2, and interlocked therein.

Also shown is the ball shaped part 9, protruding outwardly from the front of the fork leg.

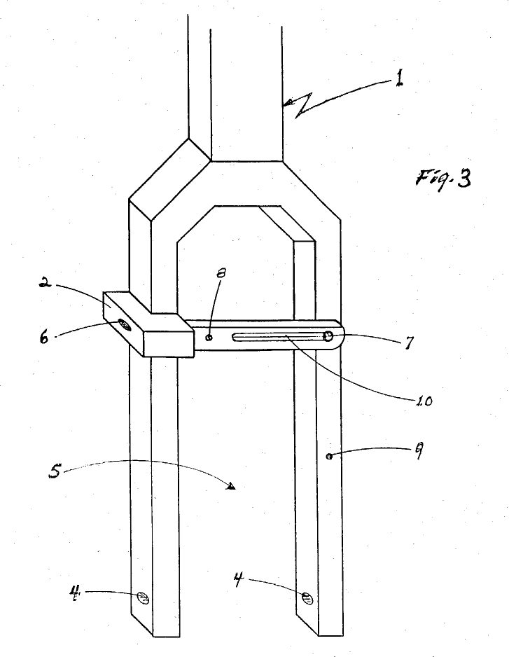

FIG. 3 illustrates a variation of the pivoting member 3.

The difference being, slot 10, which is used for sliding the member through the bicycle tire rim, instead of pivoting the member there through.

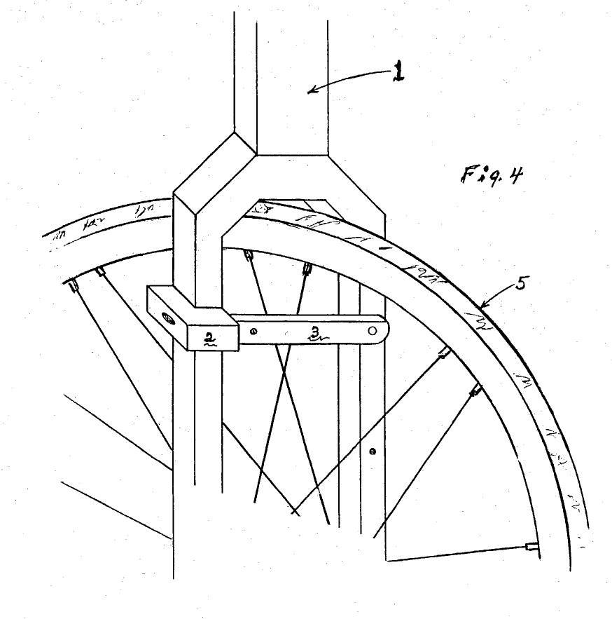

FIG. 4 shows the bicycle frame fork 1, and a bicycle tire 5, between fork members, and illustrates the pivoting member 3, pivoted through a bicycle tire spokes, or rim, and engaged with the device locking mechanism 2.

FIG. 5 shows the bicycle frame 11, with fork 1, shown in previous figures, and bicycle tire 5, between the fork legs.

FIG. 5 illustrates partial cut-away 15, of the bicycle tubing 26, so as to enable partial viewing of the securing means chain links 13, within the tubing 26.

Also shown is spring member 12, secured, anchored to the tubing by a pin 22.

The spring is connected to the chain link 13.

When the chain is fully extracted from the tubing, it engages a stop member 21, inside the tubing.

It is noted that the stop member 21, allows links 13, to pass through and afterwhich engage with larger links 14, thus preventing the chain from being extracted or retracted back into the tubing beyond its predetermined allowance of extraction or retraction.

A cut out 19, is provided in the tubing 26, in order that a person may place a finger through space 20, in chain link 14, and afterwhich extract the chain from the tubing.

A plastic sleeve 23, is provided within the tubing so as to eliminate friction between the chain and the tubing while extraction or retraction is occurring.

It is noted that bicycle tubing 26, has a straight back part 24, and further has a rounded front part at 24A, for allowing the chain to be extracted smoothly without engaging with obstructive corners within the tubing.

Also shown is a removable stop member 34, utilized for limiting insertion into straight back part 24, stop member 34, is partially located inside the tubing, as indicated by dotted lines.

The portion 25, of the tubing 26, also allows the chain to be extracted without obstruction.

Also shown in FIG. 5, is receiving locking mechanism member 16, used for receiving the chain after its extraction from the tubing, and engagement with a preferably unmovable object.

The chain is then locked in the receiving member at 18.

It is noted that the receiving member 16, is permanently secured, fastened to the bicycle frame construction and always ready for instantaneous use.

Also shown is key slot 17, used for releasing, unlocking the chain which is automatically pulled back inside the tubing by spring member 12, after being unlocked.

Link 14, then remains ready again in cut out 19, for instantaneous use.

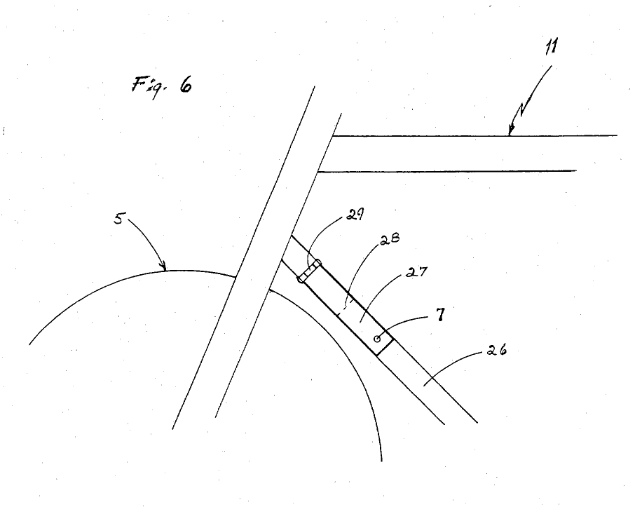

FIG. 6 shows the bicycle frame 11, illustrating a variation of the bicycle tire locking device shown in previous FIGS. 1-4.

In this variation it is noted that the device 27, is secured, fastened to a different place on the bicycle frame.

It is further noted that variation device 27, is secured to an out-of-the-way position, so as to not interfere with the bicycle tire while the bicycle is being ridden.

In FIG. 6, the device 27, now employs two pivoting members, wherein the device now pivots from pin 7, as illustrated in previous FIGS. 1-4, and then is brought into position with the bicycle tire as illustrated in FIG. 6, and afterwhich pivoting member 28, is then inserted, pivoted through the bicycle tire 5, and also through the bicycle tire rim which is not shown.

As illustrated in FIG. 6, a hinge 29, is employed which allows member 28, to pivot.

FIG. 6, further shows dotted lines of member 28, illustrating that the member is tucked away behind and inside the first pivoting member which pivots from pin 7.

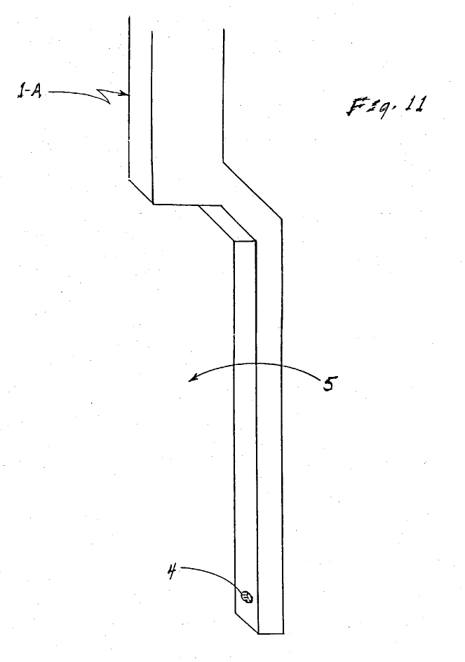

This is further illustrated in FIG. 10.

Also shown in FIG. 6, is bicycle tubing 26.

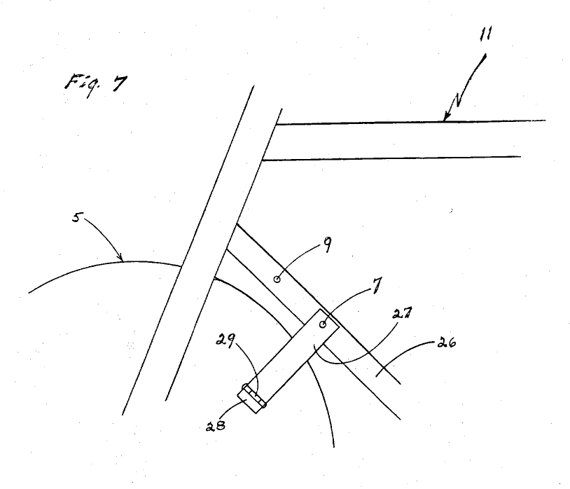

FIG. 7 illustrates member 27, now in position with the bicycle tire 5, and pivoting member 28, is now shown out from behind the first pivoting member which pivots from pin 7.

In FIG. 7, member 28, has now been inserted through the bicycle tire, the hinge 29, allows member 28, to pivot or be inserted through the bicycle tire 5.

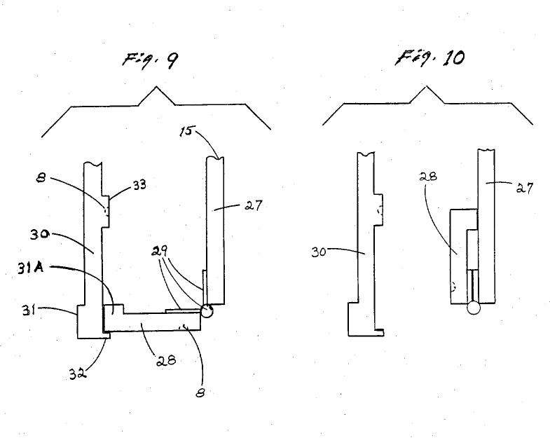

This pivoting is illustrated in FIG. 9.

Also shown in FIG. 7, is the ball shaped part 9, which is used to engage with and secure member 28, to the bicycle tubing 26, when member 27, is not in use, such as when the bicycle is being ridden.

This ball shaped part is identical to that used in FIG. 1.

See FIG. 10, which shows hole 8, located in member 28.

The hole is used to engage with the ball shaped part 9, which fits into the hole 8, and secures member 27, to tubing 26.

See also FIG. 9.

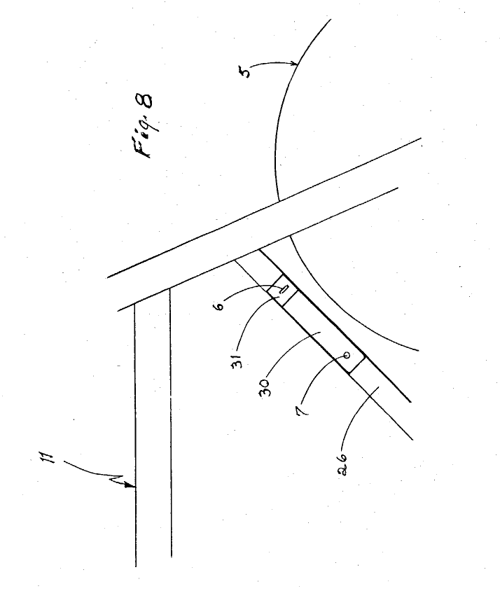

FIG. 8 shows the opposite side of the bicycle frame 11, illustrated in FIGS. 5 and 6.

FIG. 8, further shows the other side 30, of the bicycle tire locking device variation, also illustrated in FIGS. 6 and 7.

This portion of the variation also pivots from pin 7, so as to come into position with the bicycle tire 5.

See FIG. 7, for an illustration of the device coming into position with the bicycle tire.

Upon coming into position, member 30, is then ready to receive afore mentioned member 28.

See FIG. 10, for illustration.

FIG. 8, also shows locking mechanism 31, having key slot 6.

FIG. 8, also has a ball shaped part 9, located behind member 30, which is used to secure member 30, against the bicycle tubing 26.

See FIG. 7, which shows ball shaped part 9.

FIG. 9 illustrates both portions 27 and 30, of the previously mentioned variation of bicycle tire locking device now engaged together.

Member 28, is shown pivoted away from the back of member 27.

The pivoting is accomplished by use of hinge 29.

Member 28, is shown resting on ledge 32, thus bringing member 28, in contact with member 30.

The locking mechanism 31, receives portion 31A, which is connected to and part of member 28.

Portion 31A, is used to coincide with locking mechanism 31, and interlock members 31 and 31A, together.

Member 30, also shows portion 33, which is used as a spacer for correctly aligning member 30, against bicycle tubing 26, so that ledge 32, and portion 33, will be equal in width and fit evenly against the tubing 26.

See FIG. 8.

Also shown is hole 8, which is used to engage with the ball shaped part 9, and allow part 9, to be inserted into hole 8, thus holding member 30, secured against the bicycle tubing 26, in an out-of-the-way position while the bicycle is being ridden.

FIG. 9, also shows break-away 15, which illustrates that only the bottom portions of members 27, and 30, are shown and the top portions which empoly the pin 7, are not shown.

Also the bicycle tubing 26, and the bicycle tire 5, are not shown in FIGS. 9 and 10.

FIG. 10 illustrates members 27 and 30, both being in aforesaid positions and ready for engagement with each other by means of member 28, pivoting away from the back of member 27, and then coming in contact with member 30, by resting on ledge 32, and afterwhich portions 31 and 31A, are interlocked together.

FIG. 11 shows a variation 1-A, of the bicycle frame fork.

This variation employs only one leg instead of the fork shown in previous figures.

The bicycle tire 5, fits in the space adjacent the leg and is secured against the leg by the use of hole 4.

The bicycle tire is not shown.

See FIG. 6.

What is claimed is;

1. A bicycle frame comprising integral anti-theft apparatus,
said bicycle frame construction comprising tubing-type material,
said anti-theft apparatus including means stored in said tubing-type material,
said stored means utilized for securing said bicycle frame,
said stored means adapted for use by extraction of said means from said tubing,
said anti-theft apparatus further including a receiving member,
said receiving member utilized for receiving and locking said extracted means therein,
said anti-theft apparatus further including an additional member which passes through a bicycle tire and afterwhich engages with a locking member and locks therein.

2. A non-motorized bicycle frame construction,
a portion of said bicycle frame construction comprising upright members, and a member connecting said upright members together,
said upright members comprising one upright member whereon a handlebar may be attached by insertion thereinto,
and whereon another upright member a seat may be attached by insertion thereinto,
said connecting member located between said upright member whereon a handlebar may be attached,
and between said another upright member whereon a seat may be attached,
said members constructed of tubular material,
said bicycle frame construction having an intentional design comprising integral anti-theft apparatus,
said intentional design, integral anti-theft apparatus included with the bicycle when the frame is constructed,
said anti-theft apparatus set and permanently positioned and continuously ready for instantaneous use,
said anti-theft apparatus comprising means stored within said tubular material,
said stored means utilized for securing, locking said bicycle frame to an existing object apart from the bicycle frame,
said stored means adapted for use by extraction of said stored means from within said tubular material,
said anti-theft apparatus, means stored within said tubular material attached to a retracting member,
said retracting member secured and permanently anchored within said tubular material,
said securing and permanent anchoring located in, and to one tubing member,
while said extraction takes place from, and is located in another tubing member,
said retracting member having ability to transcend from said one tubing member and into said another tubing member simultaneously while still being said secured and permanently anchored to said one tubing member,
said retracting member utilized for maintaining a constant resisting force against said extraction of said stored means,
said retracting member automatically retracting said stored means back into said tubular material while said stored means is not being utilized,
said tubular material having an intentional design within for allowing uninterrupted said transcending, and return movement of said retracting member without obstruction of a continuous smooth movement,
said intentional design comprising transition means from one tubing member to another for allowing said continuous smooth movement,
said anti-theft apparatus further comprising an additional member secured to the bicycle frame construction,
said additional member utilized for passing through a bicycle tire, or bicycle tire spokes, or bicycle tire rim,
and afterwhich engaging with a locking member for locking the bicycle tire to the bicycle frame construction.

3. A non-motorized bicycle frame construction,
a portion of said bicycle frame construction comprising upright members, and a member connecting said upright members together,
said upright members comprising one upright member whereon a handlebar may be attached by insertion thereinto,
and whereon another upright member a seat may be attached by insertion thereinto,
said connecting member located between said upright member whereon a handlebar may be attached,
and between said another upright member whereon a seat may be attached,
said upright member whereon a seat may be attached and said connecting member constructed of tubular material,
said bicycle frame construction having an intentional design comprising integral anti-theft apparatus,
said intentional design, integral anti-theft apparatus included with the bicycle when the frame is constructed,
said anti-theft apparatus set and permanently positioned and continuously ready for instantaneous use,
said anti-theft apparatus comprising means stored within said tubular material,
said stored means utilized for securing, locking said bicycle frame to an existing object apart from the bicycle frame,
said stored means adapted for use by extraction of said stored means from within said tubular material,
said tubular member connecting said upright members together having an intentional opening therein, designed specifically for allowing said extraction of said stored means from within said tubular member,
said anti-theft apparatus, means stored within said tubular material attached to a retracting member,
said retracting member secured and permanently anchored within said tubular material,
said securing and permanent anchoring located within said upright member whereon a seat may be attached,
while said extraction takes place from, and is located in said connecting member,
said retracting member having ability to transcend from said tubing member whereon a seat may be attached, and into said connecting member simultaneously, while still being said secured and permanently anchored to said tubing member whereon a seat may be attached,
said retracting member utilized for maintaining a constant resisting force against said extraction of said stored means,
said retracting member automatically retracting said stored means back into said tubular material while said stored means is not being utilized,
said tubular material having an intentional design within for allowing uninterrupted said transcending, and return movement of said retracting member without obstruction of a continuous smooth movement,
said intentional design comprising transition means from one tubing member to another for allowing said continuous smooth movement,
said upright member whereon a seat may be attached comprising two seperate parts which converge into one,
said two seperate parts consisting of one part upon which a said bicycle seat may be attached by insertion thereinto,
and the other part which is the transition means for allowing said retracting member to transcend from one tubing member and into the other without said obstruction of continuous smooth movement,
said converging into one, therein said retracting member is secured,
said anti-theft apparatus further comprising an additional member secured to the bicycle frame construction,
said additional member utilized for passing through a bicycle tire, or bicycle tire spokes, or bicycle tire rim,
and afterwhich engaging with a locking member for locking the bicycle tire to the bicycle frame construction.

4. A non-motorized bicycle frame construction,
a portion of said bicycle frame construction comprising upright members, and a member connecting said upright members together,
said upright members comprising one upright member whereon a handlebar may be attached by insertion thereinto,
and whereon another upright member a seat may be attached by insertion thereinto,
said connecting member located between said upright member whereon a handlebar may be attached,
and between said another upright member whereon a seat may be attached,
said another upright member whereon a seat may be attached and said connecting member constructed of tubular material,
said another upright member whereon a seat may be attached having a stop member for limiting said insertion thereinto,
said bicycle frame construction having an intentional design comprising integral anti-theft apparatus,
said intentional design, integral anti-theft apparatus included with the bicycle when the frame is constructed,
said anti-theft apparatus set and permanently positioned and continuously ready for instantaneous use,
said anti-theft apparatus comprising means stored within said tubular material,
said stored means utilized for securing, locking said bicycle frame to an existing object apart from the bicycle frame,
said stored means adapted for use by extraction of said stored means from within said tubular material,
said tubular member connecting said upright members together having an intentional opening therein, designed specifically for allowing said extraction of said stored means from within said tubular member,
said anti-theft apparatus, means stored within said tubular material attached to a retracting member,
said retracting member secured and permanently anchored within said tubular material,
said securing and permanent anchoring located within said upright member whereon a seat may be attached,
while said extraction takes place from, and is located in said connecting member,
said retracting member having ability to transcend from said tubing member whereon a seat may be attached, and into said connecting member simultaneously, while still being said secured and permanently anchored to said tubing member whereon a seat may be attached,
said retracting member utilized for maintaining a constant resisting force against said extraction of said stored means,
said retracting member automatically retracting said stored means back into said tubular material while said stored means is not being utilized,
said tubular material having an intentional design within for allowing uninterrupted said transcending, and return movement of said retracting member without obstruction of a continuous smooth movement,
said intentional design comprising transition means from one tubing member to another for allowing said continuous smooth movement,
said upright member whereon a seat may be attached comprising two seperate parts which converge into one,
said two seperate parts consisting of one part upon which a said bicycle seat may be attached by insertion thereinto,
and the other part which is the transition means for allowing said retracting member to transcend from one tubing member and into the other without said obstruction of continuous smooth movement,
said converging into one, therein said retracting member is secured,
said anti-theft apparatus further comprising a receiving member,
said receiving member utilized for receiving and locking said extracted stored means to said receiving member,
said locking of extracted stored means to said receiving member not requiring an external—unattached lock—not integral with said bicycle frame construction,
said anti-theft apparatus further comprising an additional member secured to the bicycle frame construction,
said additional member utilized for passing through a bicycle tire, or bicycle tire spokes, or bicycle tire rim,
and afterwhich engaging with a locking member for locking the bicycle tire to the bicycle frame construction.

5. A non-motorized bicycle frame construction,
a portion of said bicycle frame construction comprising upright members, and a member connecting said upright members together,
said upright members comprising one upright member whereon a handlebar may be attached by insertion thereinto,
and whereon another upright member a seat may be attached by insertion thereinto,
said connecting member located between said upright member whereon a handlebar may be attached,
and between said another upright member whereon a seat may be attached,
said members constructed of tubular material,
said bicycle frame construction having an intentional design comprising integral anti-theft apparatus,
said intentional design, integral anti-theft apparatus included with the bicycle when the frame is constructed,
said anti-theft apparatus set and permanently positioned and continuously ready for instantaneous use,
said anti-theft apparatus comprising means stored within said tubular material,
said stored means utilized for securing, locking said bicycle frame to an existing object apart from the bicycle frame,
said stored means adapted for use by extraction of said stored means from within said tubular material,
said anti-theft apparatus, means stored within said tubular material attached to a retracting member,
said retracting member secured and permanently anchored within said tubular material,
said securing and permanent anchoring located in and to one tubing member,
while said extraction takes place from and is located in another tubing member,
said retracting member having ability to transcend from said one tubing member and into said another tubing member simultaneously, while still being said secured and permanently anchored to said one tubing member,
said retracting member transcending into said another tubing member, therein said retracting member engages with a stop member,
said stop member utilized for stoping said retracting member, limiting said retracting member from external extraction,
said retracting member also utilized for maintaining a constant resisting force against said extraction of said stored means,
said retracting member automatically retracting said stored means back into said tubular material while said stored means is not being utilized,
said tubular material having an intentional design within for allowing uninterrupted said transcending, and return movement of said retracting member without obstruction of a continuous smooth movement,
said intentional design comprising transition means from one tubing member to another for allowing said continuous smooth movement,
said anti-theft apparatus further comprising an additional member secured to the bicycle frame construction,
said additional member utilized for passing through a bicycle tire, or bicycle tire spokes, or bicycle tire rim,
and afterwhich engaging with a locking member for locking the bicycle tire to the bicycle frame construction.

6. A non-motorized bicycle frame construction,
a portion of said bicycle frame construction comprising upright members, and a member connecting said upright members together,
said upright members comprising one upright member whereon a handlebar may be attached by insertion thereinto,
and whereon another upright member a seat may be attached by insertion thereinto,
said connecting member located between said upright member whereon a handlebar may be attached,
and between said another upright member whereon a seat may be attached,
said members constructed of tubular material,
said bicycle frame construction having an intentional design comprising integral anti-theft apparatus,
said intentional design, integral anti-theft apparatus included with the bicycle when the frame is constructed,
said anti-theft apparatus set and permanently positioned and continuously ready for instantaneous use,
said anti-theft apparatus comprising means stored within said tubular material,
said stored means utilized for securing, locking said bicycle frame to an existing object apart from the bicycle frame,
said stored means adapted for use by extraction of said stored means from within said tubular material,
said anti-theft apparatus, means stored within said tubular material attached to a retracting member,
said retracting member secured and permanently anchored within said tubular material,
said securing and permanent anchoring located in, and to one tubing member,
while said extraction takes place from, and is located in another tubing member,
said retracting member having ability to transcend from said one tubing member and into said another tubing member simultaneously while still being said secured and permanently anchored to said one tubing member,
said retracting member utilized for maintaining a constant resisting force against said extraction of said stored means,
said retracting member automatically retracting said stored means back into said tubular material while said stored means is not being utilized,
said tubular material having an intentional design within for allowing uninterrupted said transcending, and return movement of said retracting member without obstruction of a continuous smooth movement,
said intentional design comprising transition means from one tubing member to another for allowing said continuous smooth movement,
said anti-theft apparatus further comprising a receiving member,
said receiving member utilized for receiving and locking said extracted stored means to said receiving member,
said locking of extracted stored means to said receiving member not requiring an external—unattached lock—which is not integral with the bicycle frame construction,
said anti-theft apparatus further comprising an additional member secured to the bicycle frame construction,
said additional member utilized for passing through a bicycle tire, or bicycle tire spokes, or bicycle tire rim,
and afterwhich engaging with a locking member for locking the bicycle tire to the bicycle frame construction.
